(19) United States
(12) Patent Application Publication
(10) Pub. No.: US 2025/0135717 A1
(43) Pub. Date: May 1, 2025

(54) ADDITIVE MANUFACTURED PARTS BY USING FIBRE CONTAINING FILAMENT CONTROLLING ELASTICITY AND ELONGATION

(71) Applicants: Airbus Americas, Inc., Mobile, AL (US); Airbus Operations GmbH, Hamburg (DE)

(72) Inventors: Michael Telkamp, Hamburg (DE); Dirk Humfeldt, Hamburg (DE); Jeffrey Nangle, Wichita, KS (US)

(21) Appl. No.: 18/385,675

(22) Filed: Oct. 31, 2023

(51) Int. Cl. B29C 64/165; B29C 64/118; B29C 64/209; B29C 64/393; B29K 21/00; B29K 105/10; B33Y 10/00; B33Y 30/00; B33Y 40/20; B33Y 50/02; B33Y 70/10

(52) U.S. Cl. CPC B29C 64/165; B29C 64/118; B29C 64/209; B29C 64/393; B33Y 10/00; B33Y 30/00; B33Y 40/20; B33Y 50/02; B33Y 70/10; B29K 2021/003; B29K 2105/101

(57) ABSTRACT

A system for making a component having a plurality of layers sequentially deposited via additive manufacturing has a nozzle and a print controller. The nozzle has an orifice. The print controller defines a print pattern for the nozzle for each layer of the component. The print pattern defines a print order in which filaments are deposited from the nozzle to form one of the plurality of layers of the component. A cutter at the orifice of the nozzle is used to cut the filament as required according to the print pattern. The nozzle moves according to the print pattern for the layer of the component being formed and simultaneously coextrude an elastomeric matrix material and a reinforcing material from the orifice of the nozzle as one of the filaments, such that the reinforcing material is entirely internal to the elastomeric matrix material.

### TECHNICAL FIELD

The disclosure herein relates to systems and methods for additively manufacturing a component having, in one or more (e.g., as many as all) layers thereof, a reinforcing material embedded therein by being extruded simultaneously with a matrix material from an extrusion head.

### BACKGROUND

Fibers are embedded within elastomeric components to control the mechanical properties of the component. However, such fiber-reinforced elastomeric parts are not manufactured using additive manufacturing. At present, elastomeric parts that are made via additive manufacturing are made using elastomeric filaments that are not reinforced. It is known to utilize additive manufacturing in making components that are irregularly shaped and/or are not suitable to be formed using conventional manufacturing methods. However, the inability to embed a reinforcing material, such as one or more fibers, within some or all portions of such elastomeric components formed via additive manufacturing has limited the ability to utilize additive manufacturing in forming components that must have a controlled elongation and/or elasticity.

### SUMMARY

This summary lists several embodiments of the presently disclosed subject matter, and in many cases lists variations and permutations of these embodiments. This summary is merely exemplary of the numerous and varied embodiments. Mention of one or more representative features of a given embodiment is likewise exemplary. Such an embodiment can typically exist with or without the feature(s) mentioned; likewise, those features can be applied to other embodiments of the presently disclosed subject matter, whether listed in this summary or not. To avoid excessive repetition, this summary does not list or suggest all possible combinations of such features.

The following presents a summary to provide a basic understanding of one or more embodiments of the disclosure. This summary is not intended to identify key or critical elements, or to delineate any scope of particular embodiments or any scope of the claims. Its sole purpose is to present concepts in a simplified form as a prelude to the more detailed description that is presented later.

### BRIEF DESCRIPTION OF THE DRAWINGS

The presently disclosed subject matter can be better understood by referring to the following figures. The components in the figures are not necessarily to scale, emphasis instead being placed upon illustrating the principles of the presently disclosed subject matter (often schematically). In the figures, like reference numerals designate corresponding parts throughout the different views. A further understanding of the presently disclosed subject matter can be obtained by reference to an embodiment set forth in the illustrations of the accompanying drawings. Although the illustrated embodiment is merely an example of systems for carrying out the presently disclosed subject matter, both the organization and method of operation of the presently disclosed subject matter, in general, together with further objectives and advantages thereof, may be more easily understood by reference to the drawings and the following description. The drawings are not intended to limit the scope of this presently disclosed subject matter, which is set forth with particularity in the claims as appended or as subsequently amended, but merely to clarify and exemplify the presently disclosed subject matter.

FIG. 1 is a schematic top view of an example embodiment of a layer of a component formed by dispensing a plurality of filaments during an additive manufacturing process.

FIG. 2 is a schematic top view showing an example sequential printing pattern for dispensing the filaments to form the layer of the component of FIG. 1.

FIG. 3 is a schematic top view of another example embodiment of a layer of a component formed by continuously dispensing a filament during an additive manufacturing process.

FIG. 4 is a schematic top view of the layer of the component of FIG. 3, with the filament having an end thereof anchored in place to secure the end of the filament in place while the print head moves during the additive manufacturing process.

FIG. 5 is a schematic side view of an example embodiment of a print head for use in an additive manufacturing process for co-extruding a reinforcing material and a matrix material from the print head in a form of a filament.

FIG. 6 is a schematic side view of another example embodiment of a print head for use in an additive manufacturing process for co-extruding a reinforcing material and a matrix material from the print head in a form of a filament.

FIG. 7 is a schematic top, or axial, view of the roller system of the print head of FIG. 6, showing the roller system engaging with the reinforcing material within the print head.

FIG. 8 is a schematic side view of another example embodiment of a print head for use in an additive manufacturing process for co-extruding a reinforcing material and a matrix material from the print head in a form of a filament.

FIG. 9 is a cross-sectional view of the print head along the cut plane 9-9 shown in FIG. 8.

FIG. 10A is a schematic illustration of an example layer of a component formed via additive manufacturing.

FIG. 10B is a schematic illustration of another example layer of a component formed via additive manufacturing.

FIG. 10C is a schematic illustration of yet another example layer of a component formed via additive manufacturing.

### DETAILED DESCRIPTION

In the description below, without being restricted hereto, specific details are presented in order to give a complete understanding of the disclosure herein. It is, however, clear to a person skilled in the art that the disclosure herein may be used in other example embodiments which may differ from the details outlined below. The figures serve furthermore merely to illustrate example embodiments, are not to scale, and serve merely to illustrate by example the general concept of the disclosure herein. For example, features contained in the figures must not necessarily be considered to be essential components.

Comparable or identical components and features, or those with similar effect, carry the same reference signs in the figures. For reasons of clarity, in the figures sometimes the reference signs of individual features and components have been omitted, wherein these features and components carry reference signs in the other figures.

The presently disclosed subject matter now will be described more fully hereinafter, in which some, but not all embodiments of the presently disclosed subject matter are described. Indeed, the presently disclosed subject matter can be embodied in many different forms and should not be construed as limited to the embodiments set forth herein; rather, these embodiments are provided so that this disclosure will satisfy applicable legal requirements.

The terminology used herein is for the purpose of describing particular embodiments only and is not intended to be limiting of the presently disclosed subject matter.

While the following terms are believed to be well understood by one of ordinary skill in the art, the following definitions are set forth to facilitate explanation of the presently disclosed subject matter.

All technical and scientific terms used herein, unless otherwise defined herein, are intended to have the same meaning as commonly understood by one of ordinary skill in the art. References to techniques employed herein are intended to refer to the techniques as commonly understood in the art, including variations on those techniques or substitutions of equivalent techniques that would also be apparent to one of skill in the art. While the following terms are believed to be well understood by one of ordinary skill in the art, the following definitions are set forth to facilitate explanation of the presently disclosed subject matter.

In describing the presently disclosed subject matter, it should be understood that a number of techniques, features, steps, etc. are disclosed. Each of these has individual benefit and each can also be used in conjunction with one or more, or in some cases all, of the other disclosed techniques, features, steps, etc.

Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Following long-standing patent law convention, the terms “a”, “an”, and “the” refer to “one or more” when used in this application, including the claims.

Thus, for example, reference to “a vertical post” includes a plurality of such vertical posts, and so forth.

Unless otherwise indicated, all numbers expressing quantities of structures, features, and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

As used herein, the term “about,” when referring to a value or to an amount of a composition, dose, mass, weight, temperature, time, volume, concentration, percentage, etc., is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate for the disclosed devices, compositions, systems and/or methods.

The term “comprising,” which is synonymous with “including,” “containing,” and/or “characterized by,” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or feature not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

As used herein, the term “and/or,” when used in the context of a listing of entities, refers to the entities being present singly or in any combination. Thus, for example, the phrase “A, B, C, and/or D” includes A, B, C, and D individually, but also includes any and all combinations and subcombinations of A, B, C, and

D.

It will be understood that various details of the presently disclosed subject matter may be changed without departing from the scope of the presently disclosed subject matter. Furthermore, the foregoing description is for the purpose of illustration only, and not for the purpose of limitation.

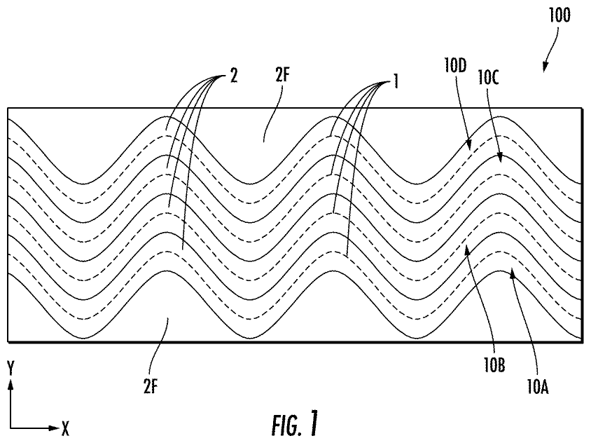

FIG. 1 is a top view of a component layer, generally designated 100. The component layer 100 is shown as having a generally rectangular shape, but this is merely an example. The component layer 100 can have any suitable shape, including having one or more voids or cavities formed therein, on, in, and/or within a perimeter of the component layer 100. The component layer 100 can, in some instances, define the entirety of the component, meaning that the component is a uni-layer structure. The component layer 100 comprises a plurality of filaments 10A-D that are deposited according to a predefined print pattern based on the component layer 100 being formed. In the example component layer 100, each filament 10A-D is deposited directly adjacent to at least one other filament 10A-D. Thus, each filament 10A-D is directly attached to at least one other filament 10A-D.

Each filament 10A-D comprises a reinforcing material 1 and a matrix material 2. The reinforcing material 1 can be one or more (e.g., a plurality of) longitudinally-extending members that are embedded within the matrix material. Non-limiting examples of the reinforcing material 1 include woven fibers, nonwoven fibers, carbon fibers, and the like. In some instances, the reinforcing material 1 comprises or consists of a metal. The matrix material 2 comprises or consists of an elastomeric material. The matrix material 2 is an elastomeric material that is viscous when extruded from the nozzle but hardens after being dispensed from the nozzle. In some embodiments, the elastomeric material is thermoplastic. In some embodiments, the elastomeric material is a multi-component (e.g., hardener and resin) elastomeric polymer and cures after the components thereof are mixed together. In some embodiments, an energy source is provided to apply a curing energy to cure the elastomeric material. Non-limiting examples of energy types that can be used include ultraviolet (UV) light, gamma ray radiation, and electron beam (EB).

By moving the nozzle and extruding the filaments according to the print pattern for each component layer 100, the reinforcing material 1 can be oriented internal to the component layer 100 such that the elasticity and/or elongation properties of the component layer are different than if the component layer 100 were devoid of the reinforcement layer (e.g., if the filaments 10A-D consisted of the matrix material 2). For example, in the component layer 100, upon applying an elongating force to the component layer 100 in the X-direction, the extent of elongation of the component layer 100 is limited because, as the component layer 100 is elongated, the reinforcing material 1 in each of the filaments 10A-D is progressively straightened. The shape of the filaments 10A-D can be selected to control a maximum elongation of the component layer 100.

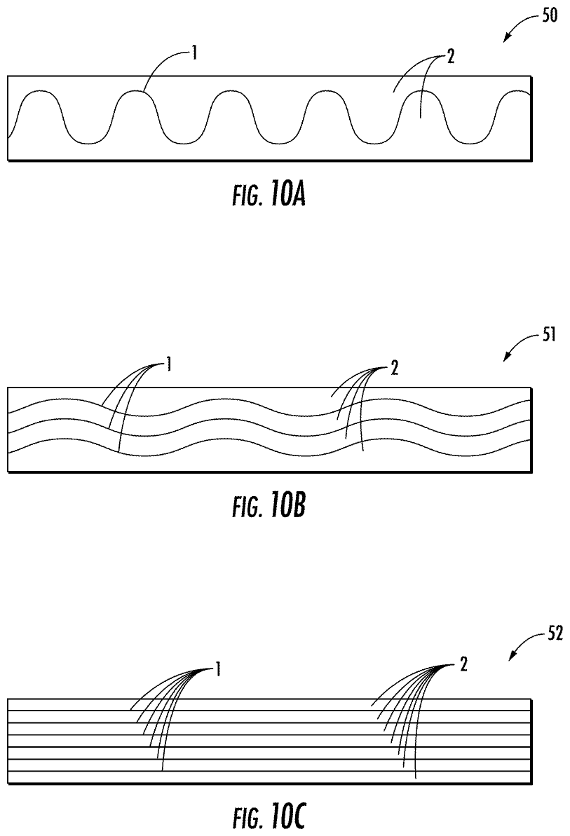

FIGS. 10A-C show examples of different arrangements of reinforcing material 1 within a component layer. In FIG. 10A, the reinforcing material 1 is embedded within the matrix material 2 of the component layer 50 in a substantially sinusoidal pattern. In addition to the maximum elongation of the matrix material 2, the amplitude of the sinusoidal pattern of the reinforcing material 1 determines the maximum elongation of the component layer 50 that is allowed by the reinforcing material 1. The arrangement of the reinforcing material 1 is advantageously selected such that elongation of the component layer 50 is limited by the reinforcing material 1 becoming straight rather than from a failure of the matrix material 2 due to excessive elongation. The component layer 51 shown in FIG. 10B shows an example in which the reinforcing material 1 is a plurality of strands of material, such as fibers, that are embedded within the component layer 51. While the reinforcing materials 1 in the component layer 51 are also substantially sinusoidally arranged, they have a lower amplitude than the reinforcing material 1 of the component layer 50. Thus, the maximum elongation of the component layer 51 is less than for the component layer 50. The component layer 52 shown in FIG. 10C shows an example in which the reinforcing material 1 is a plurality of strands of material, such as fibers, that are embedded within the component layer 52. The reinforcing materials 1 are arranged substantially straight within the component layer 52, such that the reinforcing materials 1 act to substantially limit or restrict entirely the elongation of the component layer 52. The quantity of strands of the reinforcing material 1 can be selected based on a desired tensile strength of the reinforcing material 1.

Referring again to FIG. 1, after the filaments 10A-D have been extruded and deposited according to the print pattern, a fill matrix material 2F is applied to locations within the component layer 100 specified by the print pattern. In the example shown in FIG. 1, the fill matrix material 2F is applied such that the entire component layer 100 is filled with one of the filaments 10A-D or the fill matrix material 2F. The fill matrix material 2F can be the same or a different material as the matrix material 2. In some instances, the print pattern can define one or more holes, voids, or cavities within the component layer 100, such holes, voids, or cavities being areas or regions that are devoid of the fill matrix material 2F and the filaments 10A-D. The fill matrix material 2F can be applied using a nozzle from which the fill matrix material 2F is extruded; this nozzle can be the same nozzle or a different nozzle from the nozzle that extrudes the filaments 10A-D therefrom.

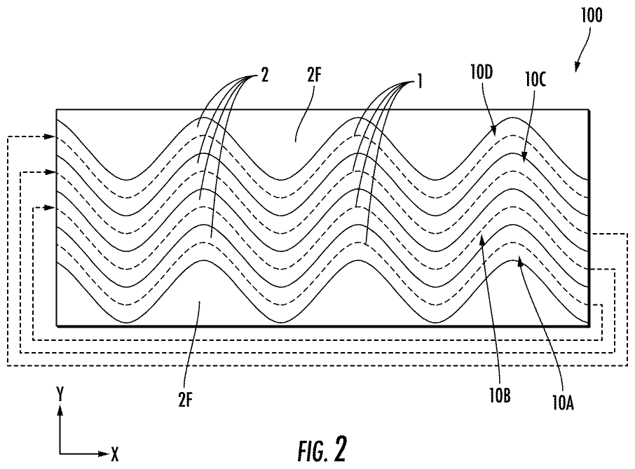

FIG. 2 shows an example print pattern for the component layer 100, in which the filaments are deposited in a sequential order, from a start (left) edge to a finish (right) edge. Thus, the nozzle moves generally left-to-right in the generally sinusoidal pattern shown to deposit the first filament 10A. A cutter is then used to sever the first filament 10A at the finish edge and the nozzle then returns to the start edge. The nozzle is indexed in the Y-direction by the thickness of the first filament 10A, so that the second filament 10B is deposited directly adjacent to the first filament 10A, rather than on top of the first filament 10A. The nozzle then moves generally left-to-right in the generally sinusoidal pattern shown to deposit the second filament 10B. The cutter is then used to sever the second filament 10B at the finish edge and the nozzle then returns to the start edge. The nozzle is indexed in the Y-direction by the thickness of the second filament 10B, so that the third filament 10C is deposited directly adjacent to the second filament 10B, rather than on top of the second filament 10B. The nozzle then moves generally left-to-right in the generally sinusoidal pattern shown to deposit the third filament 10C. The cutter is then used to sever the third filament 10C at the finish edge and the nozzle then returns to the start edge. The nozzle is indexed in the Y-direction by the thickness of the third filament 10C, so that the fourth filament 10D is deposited directly adjacent to the third filament 10C, rather than on top of the third filament 10C. The nozzle then moves generally left-to-right in the generally sinusoidal pattern shown to deposit the fourth filament 10D. The cutter is then used to sever the fourth filament 10D at the finish edge. The same or a different nozzle is then used to extrude the fill matrix material 2F in areas of the component layer 100 that are designated according to the print pattern to receive the fill matrix material 2F therein. The fill matrix material 2F is not necessarily limited to being formed via extrusion from a nozzle and can be formed in any suitable manner without limitation. The print pattern shown in FIG. 2 can be referred to as being a unidirectional print pattern.

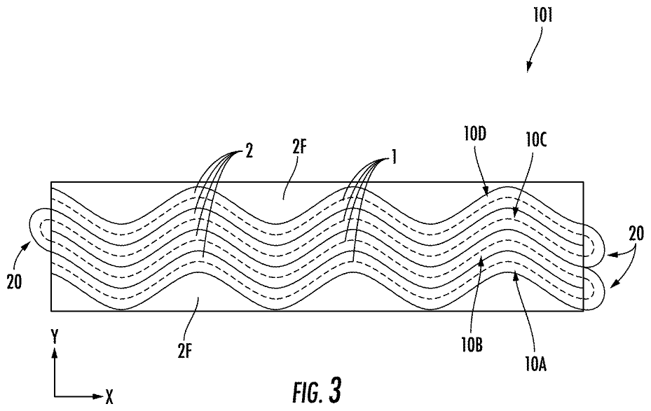

FIG. 3 shows a component layer, generally designated 101, that is formed by an additive manufacturing process using a continuous, bidirectional print pattern. In this example, the four filaments 10A-D are dispensed as one continuous filament, with the portions of the filaments 10A-D where the nozzle reversed its direction, referred to as turns 20, being outside of the boundary of the component layer 101. Thus, the filaments 10A-D are dispensed first and then the turns 20 can be removed to form four filaments 10A-D that are laterally attached together, but which are then no longer continuous with each other due to the removal of the turns 20. After the filaments 10A-D have been extruded and deposited bidirectionally, according to the print pattern, a fill matrix material 2F is applied to locations within the component layer 101 specified by the print pattern. In the example shown in FIG. 3, the fill matrix material 2F is applied such that the entire component layer 100 is filled with one of the filaments 10A-D or the fill matrix material 2F.

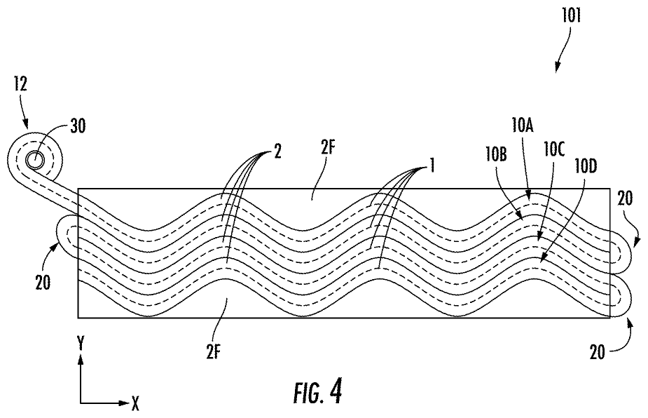

FIG. 4 is an alternative example embodiment of how the component layer 101 can be formed using the continuous, bidirectional print pattern. A filament anchor, generally designated 12, is first formed by wrapping a portion of the filament around a post 30. Thus, the filament is held in place by the engagement of the filament anchor 12 with the post 30, such that the filaments 10A-D can be pulled out of the nozzle as the nozzle moves according to the print pattern. The print pattern in FIG. 4 is reverse the print pattern for FIG. 3, with the first filament 10A being formed by moving the nozzle away from the post 30, reversing direction at the turn 20, forming the second filament 10B, reversing direction at the turn 20, forming the third filament 10C, reversing direction at the turn 20, and then forming the fourth filament 10D. Similarly to FIG. 3, the turns 20 can then be removed to produce a component layer 101 with discontinuous filaments 10A-D, similar to the component layer 100 shown in FIGS. 1 and 2.

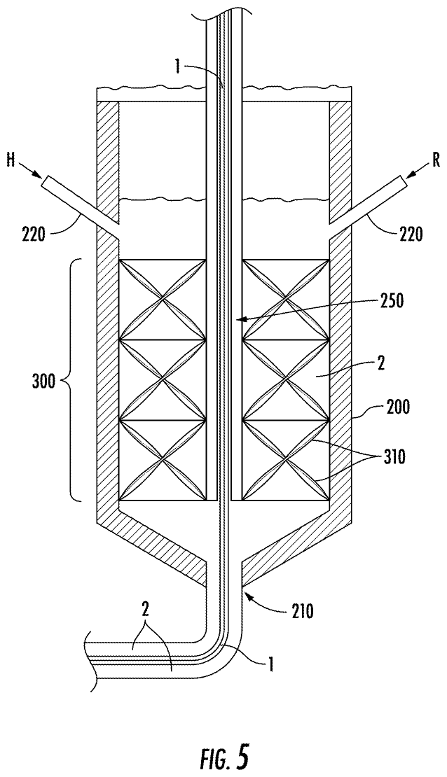

FIG. 5 is a schematic cross-sectional view of an example embodiment of a nozzle 200 for co-extruding from an orifice 210 of the nozzle a reinforcement material 1 and an elastomeric matrix material 2. In this example embodiment, the elastomeric matrix material 2 is a two-part elastomeric polymer formed by mixing together hardener H and resin R. The hardener H and the resin R are each provided within the nozzle through one of two inlets 220. The nozzle 200 has, internal thereto, a mixer 300. The mixer 300 has a plurality of mixing blades 310. The reinforcing material 1 can be any suitable type disclosed elsewhere herein, without limitation. The reinforcing material 1 passes substantially coaxially through the nozzle 200, passing through a chamber 250 that is used to separate the reinforcing material 1 from the mixers 300. The mixing blades 310 of the mixer 300 mix together the hardener H and the resin R within the nozzle to form the matrix material 2. The chamber 250 terminates after the mixer 300 to allow the matrix material 2 to infiltrate and embed (i.e., by fully wetting) the reinforcing material 1 therein as the reinforcing material moves towards and through the orifice 210. The mixer 300 can both mix together the hardener H and the resin R and also act as an impeller, pushing the matrix material 2 out of the orifice. The extrusion of the matrix material 2 form the orifice 210 is also aided by being drawn out of the orifice 210 as the reinforcing material 1 moves out of the orifice 210. The mixer 300 is schematically shown and any suitable type of mixer 300 can be used to mix together the hardener H and the resin R within the nozzle 200.

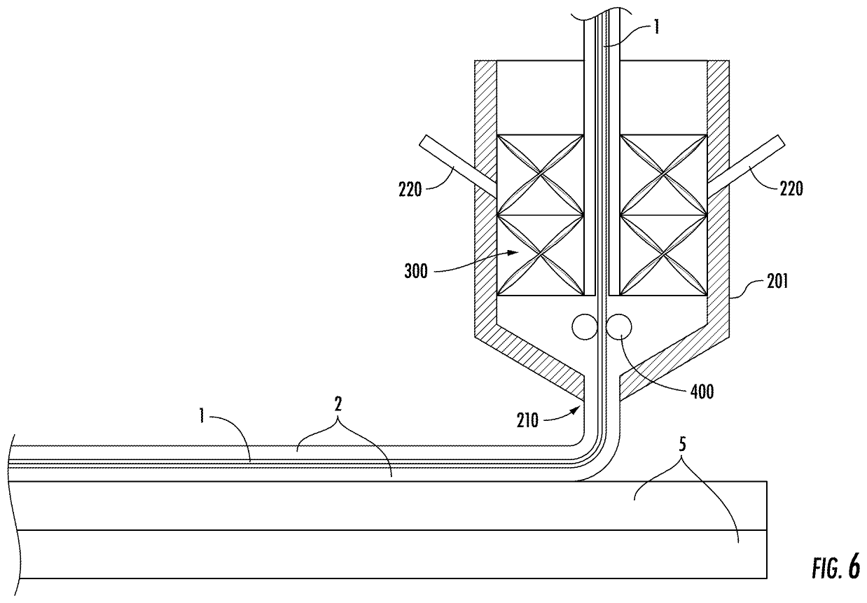

FIG. 6 is a schematic cross-sectional view of another example embodiment of a nozzle 201 for co-extruding from an orifice 210 of the nozzle a reinforcement material 1 and an elastomeric matrix material 2. In this example embodiment, the elastomeric matrix material 2 is a two-part elastomeric polymer formed by mixing together hardener H and resin R. The hardener H and the resin

R are each provided within the nozzle through one of two inlets 220. The nozzle 200 has, internal thereto, a mixer 300. The mixer 300 is substantially similar to the mixer 300 of FIG. 5. The reinforcing material 1 can be any suitable type disclosed elsewhere herein, without limitation. The reinforcing material 1 passes substantially coaxially through the nozzle 200, passing through a chamber 250 that is used to separate the reinforcing material 1 from the mixers 300. The chamber 250 terminates after the mixer 300 to allow the matrix material 2 to infiltrate and embed (i.e., by fully wetting) the reinforcing material 1 therein as the reinforcing material moves towards and through the orifice 210. The mixer 300 can both mix together the hardener H and the resin R and also act as an impeller, pushing the matrix material 2 out of the orifice. The nozzle 201 also comprises a roller guide 400 that is configured to engage with the reinforcing material 1 and push/drive the reinforcement material 1 out of the orifice 210 of the nozzle 200. The extrusion of the matrix material 2 form the orifice 210 is also aided by being drawn out of the orifice 210 as the reinforcing material 1 moves out of the orifice 210. The mixer 300 is schematically shown and any suitable type of mixer 300 can be used to mix a multi-part elastomeric polymer. As shown in FIG. 6, the filament can be extruded from the orifice 210 of the nozzle 201 and deposited onto previously deposited layers 5 of the component being formed.

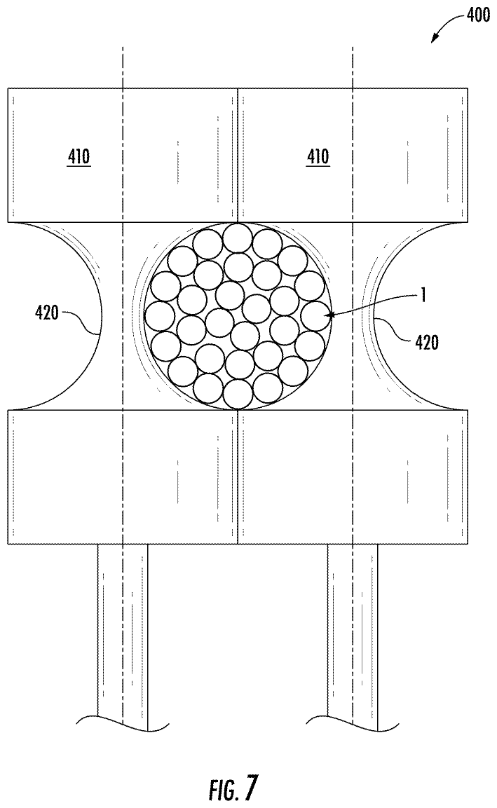

Aspects of an example embodiment of the roller guide 400 are shown in FIG. 7. As shown, the roller guide 400 comprises two roller bodies 410 that have a curved, substantially hemispheric profile on engagement surface 420. The roller bodies 410 are positioned such that the reinforcing material 1 is held between the respective engagement surface 420 of the roller bodies 410. In the view shown, the engagement profiles 420 together form a substantially circular region within which the reinforcement material 1 is frictionally engaged by the engagement surfaces 420. Thus, as the roller bodies 410 are rotated (e.g., in unison with each other), the reinforcement material 1 is driven between the roller bodies and towards the orifice 210 of the nozzle 201. The reinforcement material 1 is shown in FIG. 7 as being a plurality of strands, threads, wires, etc., but may be any suitable material and can have any number of strands, including only a single strand. The roller bodies 410 are advantageously selected to have an engagement surface 420 that is compatible to frictionally engage against the reinforcement material 1.

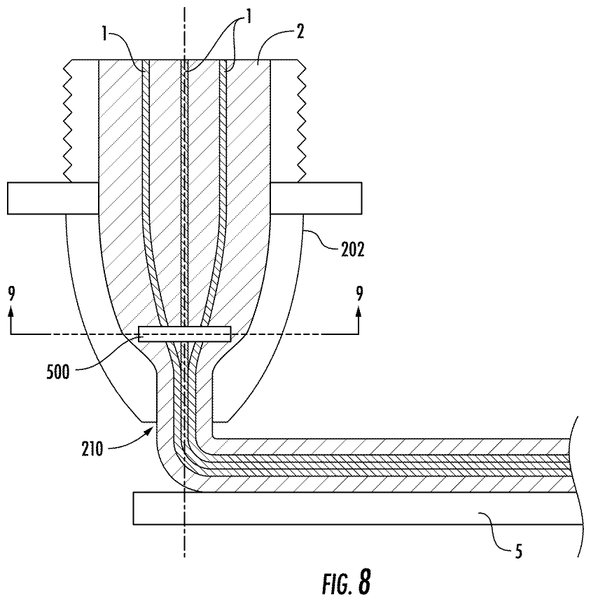

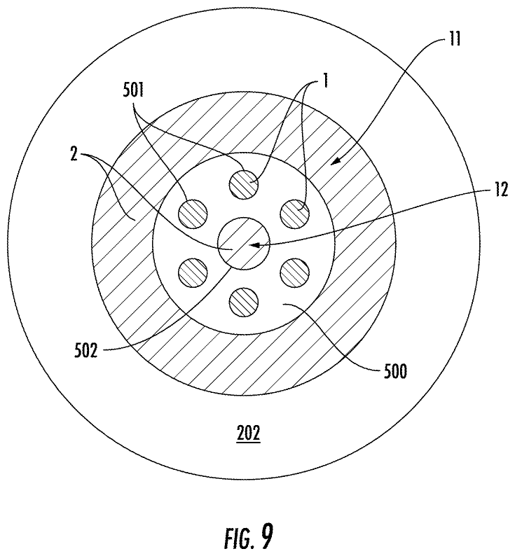

FIG. 8 is a schematic cross-sectional view of another example embodiment of a nozzle 202 for co-extruding from an orifice 210 of the nozzle a reinforcement material 1 and an elastomeric matrix material 2. In this example, the nozzle comprises a guide plate 500 internal to the nozzle 202, adjacent to the orifice 210. Aspects of the guide plate 500 are shown in the cross-sectional view taken along cut plane 9-9, in FIG. 9. The nozzle 202 is configured to receive a desired quantity of reinforcement materials 1 therein. Each of these reinforcement materials passes through a guide hole 501 formed in the guide plate 500. The guide plate is spaced apart, at least partially, from the inner walls of the nozzle 202 to define an outer region, generally designated 11, which allows the matrix material 2 within the nozzle 202 to pass around the perimeter of the guide plate 500, and also a central region, generally designated 12, which is defined by the center hole 502 formed in the guide plate 500, which allows the matrix material 2 to pass through the guide plate 500 radially internally to the reinforcing materials 1. The guide plate 500 controls an movement and spacing of the reinforcing materials 1 passing therethrough, guiding the reinforcing materials 1 towards the orifice while also centering the reinforcing materials 1 within the matrix material 2 when exiting the orifice 210. The reinforcement material 1 is shown in FIGS. 8 and 9 as being a plurality of strands, threads, wires, etc., but may be any suitable material disclosed herein and/or can have any number of strands. The matrix material 2 can be any suitable type of elastomeric matrix material disclosed elsewhere herein. As shown in FIG. 8, the filament can be extruded from the orifice 210 of the nozzle 202 and deposited onto previously deposited layers 5 of the component being formed.

In some embodiments, the matrix material disclosed herein can be provided as an elastomeric granulate material that is melted to embed the reinforcing material, or fibers, therein. The melting of the elastomeric granulate material can take place in the nozzle or in a discrete location, such that the melted elastomer is provided into the nozzle.

The systems and methods disclosed herein encompass printing paters that enable a part to be designed with controllable elasticity and elongation properties by laying up the extruded material (e.g., filaments) in different directions and/or shapes (e.g., waveform patterns), whether within the same layer and/or within different layers of the component, thus enabling controlled elongation and elasticity of the layer and/or component in at least one dimension.

The systems and methods disclosed herein allow for multi-layer elastomeric components to be produced with integrated functions, such a electrical conductivity within and/or through the component, controllable elongation in multiple dimensions, and the like. Electrical functions that may be integrated within a component can include, for example, electrical bonding, electrical conductivity to transport electrical energy, and/or integrated electrical functions to detect, for example, temperature, pressure, and the like. Mechanical functions that can be achieved using the presently disclosed systems and methods include structural reinforcement, abrasion resistance, and controllable elongation of the component in a single dimension or in multiple dimensions. In some embodiments, the system disclosed herein can have a toolhead with a plurality of print nozzles and the cutter attached thereto, such that the toolhead could be fitted with different tool and/or extrusion heads.

In some embodiments, the system comprises a temperature controllable build plate and/or build chamber, such that the temperature to which the filament is exposed during and after extrusion from the nozzle is controlled.

In some embodiments, the method comprises extruding the filament containing the matrix material and the reinforcing material according to the print pattern. Next, any gaps specified by the print patter are filled with the matrix material. If the matrix material needs to be exposed to an energy source to cure, an energy source may be provided to expose the matrix material to the appropriate type of energy to cure the matrix material. These steps are repeated, using the same or different print patterns for some or all of the layers of the component, unless the predefined number of layers for the component have been produced. If necessary, the component undergoes a final curing step. The component is then removed from the build plate and any necessary secondary finishing steps are performed on the component.

It is understood that the example embodiments disclosed herein are not limiting and do not restrict the subject matter disclosed herein. In particular, it will be evident to the person skilled in the art that the features described herein may be combined with each other arbitrarily, and/or various features may be omitted therefrom, without any resultant devices, systems, and/or methods deviating from the subject matter disclosed herein.

While at least one example embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise.

1. A system for making a component having a plurality of layers sequentially deposited via additive manufacturing, the system comprising:
a nozzle comprising an orifice;
a print controller configured to define a print pattern for the nozzle for each layer of the component, wherein the print pattern defines a print order in which filaments are deposited from the nozzle to form one of the plurality of layers of the component; and
a cutter at the orifice of the nozzle and configured to cut the filament, including the reinforcing material contained therein, when specified by the print pattern;
wherein the nozzle is configured to move according to the print pattern for the layer of the component being formed and simultaneously coextrude an elastomeric matrix material and a reinforcing material from the orifice of the nozzle as one of the filaments, such that the reinforcing material is fully immersed within the elastomeric matrix material.

2. The system of claim 1, wherein the print controller is configured to dispense the filament according to a different print pattern in different layers of the component, such that the elongation and/or the elasticity of the different layers is different from each other.

3. The system of claim 1, wherein the reinforcing material is one or more fibers having a tensile strength that is greater than a tensile strength of the elastomeric matrix material.

4. The system of claim 1, comprising a second nozzle configured to dispense only the elastomeric matrix material to fill in spaces within the layer of the component that are designated to be filled with the elastomeric matrix material but devoid of the reinforcing material.

5. The system of claim 1, wherein the nozzle comprises a mixer configured to intermix at least two components of an elastomeric polymer within the nozzle, such that the elastomeric matrix material is the elastomeric polymer, the at least two components being a resin, a hardener, one or more pigments, and/or a softener.

6. The system of claim 1, wherein the print pattern is a continuous print pattern, in which the filament is deposited in a continuous manner from the orifice for the layer of the component.

7. The system of claim 1, comprising a build plate that is configured to control a surface temperature thereof, wherein the nozzle is configured to form a first layer of the plurality of layers of the component directly on the build plate.

8. The system of claim 1, comprising a build chamber that is configured to control an internal temperature thereof, wherein the nozzle is configured to form the layer of the component within the build chamber.

9. The system of claim 1, comprising an energy source configured to cure the elastomeric matrix material.

10. The system of claim 1, wherein the nozzle is configured to extrude the elastomeric matrix material substantially concentrically around the reinforcing material, such that the reinforcing material is fully immersed in the elastomeric matrix material.

11. A method for making a component having a plurality of layers sequentially deposited via additive manufacturing, the method comprising:
providing a nozzle;
providing, for each layer of the component, a print pattern, the print pattern defining a print order in which filaments are deposited from the nozzle to form one of the plurality of layers of the component;
moving the nozzle according to the print pattern for the layer of the component being formed and simultaneously coextruding an elastomeric matrix material and a reinforcing material from an orifice of the nozzle as one of the filaments, such that the reinforcing material is fully immersed within the elastomeric matrix material; and
cutting, using a cutter at the orifice of the nozzle, the filament, including the reinforcing material contained therein, when specified by the print pattern;
wherein, by following the print pattern for the layer of the component being formed, the nozzle arranges the reinforcement material of the filaments of the layer of the component so that an elongation and/or an elasticity of the layer of the component is controlled.

12. The method of claim 11, wherein the print pattern is different in at least two layers of the plurality of layers of the component, such that the elongation and/or the elasticity is different between the at least two layers.

13. The method of claim 11, wherein the reinforcing material is one or more fibers having a tensile strength that is greater than a tensile strength of the elastomeric matrix material.

14. The method of claim 11, wherein, for each of the plurality of layers of the component, the print pattern specifies any spaces that are designated to be filled with the elastomeric matrix material but devoid of the reinforcing material only the elastomeric matrix material, the method comprising extruding the elastomeric matrix material from a second nozzle to fill in any of the spaces with the elastomeric matrix material, such that the spaces specified in the printing pattern are devoid of the reinforcing material.

15. The method of claim 11, wherein the nozzle comprises a mixer, the method comprising using the mixer to intermix at least two components of an elastomeric polymer within the nozzle, such that the elastomeric matrix material is the elastomeric polymer, the at least two components being a resin, a hardener, one or more pigments, and/or a softener.

16. The method of claim 11, wherein the print pattern is a continuous print pattern, such that the filament is deposited in a continuous manner from the orifice for the layer of the component.

17. The method of claim 11, comprising providing a build plate and controlling a surface temperature of the build plate, wherein the nozzle forms a first layer of the plurality of layers of the component on the build plate.

18. The method of claim 11, comprising providing a build chamber and controlling an internal temperature of the build chamber, wherein the nozzle forms each layer of the plurality of layers of the component within the build chamber.

19. The method of claim 11, comprising using an energy source to cure the elastomeric matrix material of the component.

20. The method of claim 11, wherein the nozzle extrudes the elastomeric matrix material substantially concentrically around the reinforcing material, such that the reinforcing material is fully immersed in the elastomeric matrix material.
